(19) United States
(12) Patent Application Publication
(10) Pub. No.: US 2020/0288669 A1
(43) Pub. Date: Sep. 17, 2020

(54) Foldable Raised Pet Feeding Stand with vertical backboard displaying advertisements, promotions, inspirational messages, and entertainment

(71) Applicants: Cordula Maring-Teichmann, Dahlonega, GA (US); John Bernardo Parella, Cumming, GA (US)

(72) Inventors: Cordula Maring-Teichmann, Dahlonega, GA (US); John Bernardo Parella, Cumming, GA (US)

(21) Appl. No.: 16/298,587

(22) Filed: Mar. 11, 2019

(51) Int. Cl. A01K 5/01

(52) U.S. Cl. CPC A01K 5/0135

(57) ABSTRACT

A Foldable Raised Pet Feeding Stand with extended height vertical backboard capable of displaying detailed 4-color process printed advertisements, promotions, inspirational messages, and entertainment. The invention adds to a conventional raised pet feeder a vertical graphic backboard panel behind the feeding deck, thereby doubling as a backsplash/splash-guard preventing food or liquids from damaging the surface behind the Feeding Stand. The graphics on the billboard panel can correspond to continuing artwork on all visible surfaces of the feeder therefore making the feeder a three-dimensional artistic exhibit. The Stand is constructed of Polypropylene coated paper adhered to fluted corrugated paperboard making the assembled feeding stand water-resistant, extending the products lifespan, additionally this feature allows for easy clean-up. Through its unique die-cut design it ships flat and folds-for-use in less than 30 seconds and un-folds for efficient storage and transportation even faster.

### FIELD OF THE INVENTION

This invention relates generally to supplies for pets, and more specifically, to food and water bowls for pets, and, even more specifically to raised pet feeding stations for feeding domesticated animals such as dogs and cats. In particular a collapsible raised pet feeding stand with an extended vertical backboard.

### BACKGROUND OF THE INVENTION

As the feeding of domesticated animals like cats and dogs has evolved over time the raised pet feeder has come to prominence due to is health and wellness benefits to the animal. Dogs with Acid Reflux benefit from elevated feeders as when they lower their heads down to the floor to eat, gravity works against them, older and arthritic pets can easily become undernourished and/or dehydrated as bending over to access a bowl placed on the floor can be painful. These are just a few of the health and wellness issues addressed in the use of raised pet feeding apparatus. Pet owners have pet feeding bowls in their kitchen, which has evolved into a design and fashion focal-point of the home, so style and design has become increasingly more important. Though conventional raised pet feeders address this issue to some extent, they are limited in design, generally a one-time purchase and not specifically designed for selection, variety, or interchangeability. Currently no raised pet feeding stations are designed using collapsible paper-based substrates making them convenient and affordable allowing the home-owner to change the raised feeder stand to match holiday, seasonal, and occasional decorations.

### BRIEF SUMMARY OF THE INVENTION

The invention is an easy to assemble fold-for-use collapsible water-resistant paper-based, graphically enhanced raised pet feeding stand with an innovative extended multipurpose backboard behind the feeding deck that doubles as a splash-guard/backsplash and also an efficient message-board/billboard/marquee that can be used to deliver advertisement, promotion, inspirational messages, photos, or simply entertainment and decorative graphics.

The invention is die-cut from one continuous piece of Polypropylene coated paper adhered to a corrugated paper board material substrate. The polypropylene coated corrugated paper-board construction allows it to accommodate vivid black & white to 4 color process printing of compelling graphics, colors, and/or art on all visible surfaces of the assembled product making it a 3-dimensional work of art and home decoration, in addition to its primary function of a raised pet feeding stand. The polypropylene coating used in the construction of the invention makes this paper-based product water resistant for easy clean-up and adds longevity to the product's life span. The combination of lightweight materials adhered together in this way and the strategic folding pattern makes this fold-for-use innovation extremely durable and water-resistant when assembled.

Due to the combination of materials and folding pattern the invention quickly transforms from a flat state into a three-dimensional and durable raised pet feeding stand without the use of tools or hardware. This feature allows the invention to be folded for seasonal storage and travel, reduces transportation costs throughout the product's life cycle, and makes it more efficient for retail display.

The present applications claims priority to the earlier filed provisional application having Ser. No. 62/644,187 and hereby incorporates subject matter of the provisional application in its entirety.

### BRIEF DESCRIPTION OF THE DRAWINGS

The nature and mode of assembly/construction of the present invention will now be more fully described in the following detailed description of the invention taken with the accompanying figures in which:

FIG. 1 is a perspective view of the assembled raised pet feeder stand according to the original embodiment of the invention. All visible panels accommodate vivid black & white to 4 color process printing of compelling graphics, colors, and/or art.

FIG. 2 is a top down view of the die-cut pattern of one continuous piece of Polypropylene coated paper stock adhered to one continuous piece of fluted corrugated paperboard, showing the complete product layout. All visible panels accommodate vivid black & white to 4 color process printing of compelling graphics, colors, and/or art.

FIG. 3 is another top down view of the die-cut pattern of one continuous piece of Polypropylene coated paper stock adhered to one continuous piece of fluted corrugated paperboard, showing the folding and adhesion of the Marquee Panel 2 and the Foundation Panel 9 to the underside of Marquee Support Panel 13 resulting in the double-wall thickness strong Backboard, and the folding and adhesion of the Left and Right Feeding Deck Reinforcement Flaps 51 and 52 to the underside of Feeding Deck 5.

FIG. 4 is a top down view of the underside of the flat laid out product showing the beginning of the assembly steps required by the consumer. By folding the Polypropylene coated paper stock otherwise open edges are strategically protected from moisture absorption.

FIG. 5 is a perspective view in which assembly steps are taken to shape the Polypropylene coated paper stock adhered to fluted corrugated paperboard into the three-dimensional Pet Feeder Stand Base.

FIG. 6 is an extrapolated view of the connecting mechanism to securely interlock the Pet Feeder Stand Base Panels in place.

FIG. 7 is a perspective view showing the interlocking Foundation Panels which are integral in the vertical support of the Feeding Deck 5 and a key component making the Invention a robust and stable Raised Pet Feeder Stand.

FIG. 8 is a perspective view showing Feeding Deck Support Panel 3 being folded across and inserted into slot 1061 adding the first layer of an essential reinforced support system for Feeding Deck 5, ensuring that the invention is sturdy enough to carry food or water for all size domesticated animals.

FIG. 9 is a perspective view showing Center Support Panel 4 being folded across Feeding Deck Support Panel 3, thereby adding another layer of support for Feeding Deck 5.

FIG. 10 is a perspective view showing Feeding Deck 5 being folded across and secured in the slot 221 which receives Flap “G” 18, revealing the Feeder Cradle, EVA foam ring with multiple triangular die cut “fingers” 19 permanently adhered around the bowl cut-out of Feeding Deck 5.

FIG. 11 is a bottom up view of the pet feeder stand showing how the four Polypropylene plastic risers/feet/cushions 221, 222, 223 and 224 are attached to the bottom edge of the folded Left and Right Base Panel 110 and 112, protecting the open fluted corrugated substrate corners 2211; 2221, 2231 and 2241 from absorbing moisture.

FIG. 12 is a perspective view of Feeding Bowl 22 being lowered into the Feeder Cradle EVA Foam Ring 19, which acts as a gasket. Additionally, the EVA foam fingers are covering the exposed corrugated substrate edges in the cut-out, thereby preventing moisture from being absorbed into the substrate.

FIG. 13 is an extrapolated view of the underside of the assembled pet feeder stand showing the Removal of the protective cover 192 from the underside of the EVA foam die-cut “fingers” 191 exposing the adhesive surface, folding the “fingers” inward and upward adhering the three Deck Panel layers firmly together solidifying the feeding deck construction.

FIG. 14 is a perspective view showing Embodiment 2 of the invention, in which Marquee Panel/Back-Board/Splash-Board/Billboard/Vertical Display Panel 21 will feature a photo cut-out, creating a Media Display Area with protective acetate cover 23 allowing the consumer to display photos, which can be easily changed.

FIG. 15 is an extrapolated view showing the assembled backside of Embodiment 2 of the invention, A finger cut-out 132 is added to the Marquee Support Panel 13 allowing the consumer to slide the photo far enough into the Media Display Area 23 to be visible and centered in the front of Marquee Panel 21.

FIG. 16 is a perspective view of Embodiment 3 of the Invention in which the extended vertical Marquee Panel/Back-Board/Splash-Board/Billboard/Vertical Display Panel has been removed, creating a Raised Pet Feeder Table.

### DETAILED DESCRIPTION OF THE INVENTION

At the outset it, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspect. The present invention is intended to include various modifications and equivalent arrangements within the spirit and scope of the apprehended claims.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one ordinary skill in the art to which this invention belongs. With respect to the current invention, dimensions should be understood as follows: height refers to the vertical elevation of a structural element; length refers to the horizontal span of a structural element; and width refers to the depth of a structural element. Although any methods, devices or materials similar or equivalent to those described herein can be used in the practice or testing of the invention, the preferred methods, devices, and materials are now described.

While certain embodiments are disclosed, still other embodiments of the present invention will become apparent to those skilled in the art from the following detailed description, which shows and describes illustrative embodiments of the invention.

The original invention is manufactured from 4-color process printed paper. Upon completion of the printing process the graphically enhanced paper is completely coated with Polypropylene to add a water-resistant surface to the paper. The paper is than adhered with glue to the fluted corrugated paper board substructure and pressed, dried and cured until permanent adhesion between the two substrates is reached. Another piece of unprinted paper is completely coated with Polypropylene to add water resistance to the surface. That paper is than glued to the backside of the fluted corrugated paper board substructure pressed, dried and cured until permanent adhesion between the two substrates is reached. Upon finishing of this step both sides of the fluted corrugated paper board are protected by Polypropylene coated paper from moisture absorption.

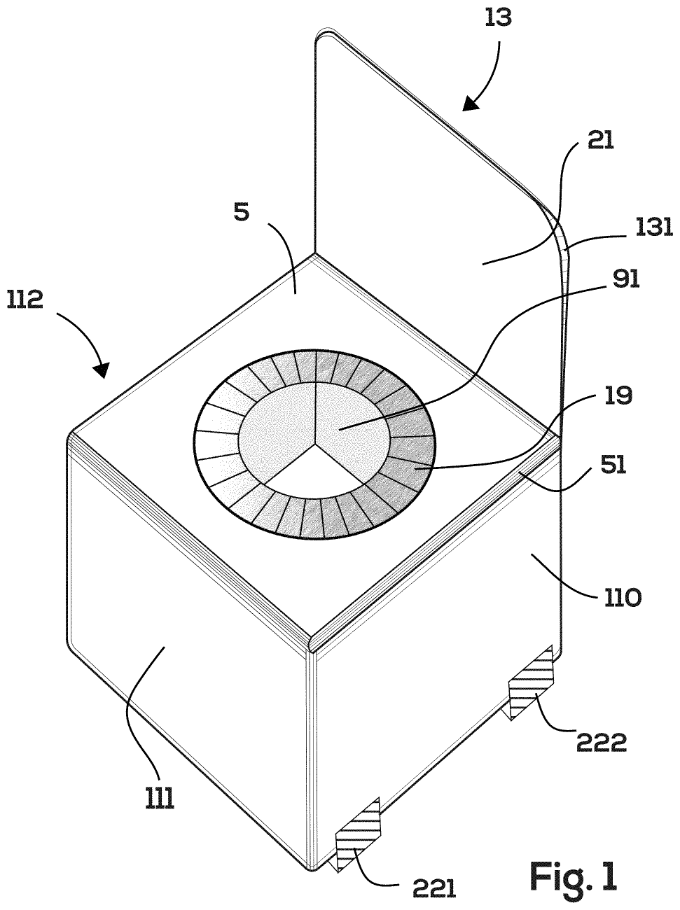

Adverting now to the Figures, FIG. 1 Embodiment 1 is a perspective view of the assembled pet feeding stand which broadly includes the assembled Marquee Panel 21 comprised of Marquee Panel/Back-Board/Splash-Board/Billboard/Vertical Display Panel 2 permanently adhered to Marquee Support Panel/Back panel 13; the Feeding Deck 5 with attached EVA foam ring with adhesive backing 19; the Left Base Panel 110, made up from Left Side Panel 10 and folded Left Foundation Panel 6; the Front Base Panel 111 made up from Front Panel 11 and folded Front Foundation Panel 7; the Right Base Panel 112, made up from Right Side Panel 12 and folded Right Foundation Panel 8; 91 comprised of Back Foundation Panel 9 folded and permanently adhered to backside of Marquee Support Panel/Back Panel 13; the complete Marquee Support Panel/Back Panel 13; and the polypropylene risers/feet/cushions 221-224. 4-color process printing showcasing compelling graphics, colors and/or art is displayed on the Marquee Panel/Back-Board/Splash-Board/Billboard/Vertical Display Panel 21 capable of delivering commercial Advertising, Promotional, Inspirational messages and/or Art. The graphics on the Marquee Panel/Back-Board/Splash-Board/Billboard/Vertical Display Panel 21 can correspond to continuing artwork on all visible surfaces of the feeder therefore making the feeder a three-dimensional artistic exhibit. 131 shows the fluted corrugated paperboard nature of the substructure.

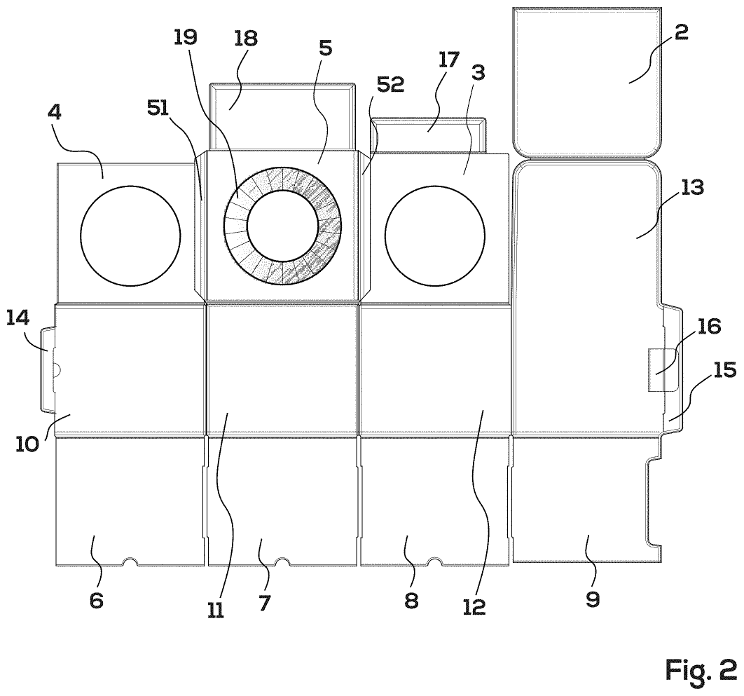

FIG. 2 shows the die-cut lines of the invention carefully laid out to make the product one continuous piece of lightweight Polypropylene coated paper adhered to fluted corrugated paperboard stock. To have the correct cutting and folding, the die line serves as an outlining template that ensures proper layout for a printed product. It is a diagram that shows all the cut and fold lines of a product in flattened form. The piece of Polypropylene coated fluted corrugated paperboard will be folded by the consumer along the score lines into the 3-dimensional Pet Feeder Stand shape with the Marquee Panel 21 rising from the back of the Feeding Deck 5. The invention is strategically constructed, so that the continuous pieces of die-cut Polypropylene coated paper, once adhered in the manufacturing process to the one continuous piece of die-cut corrugated paperboard stock, protect all surfaces of the assembled product from water or debris damage.

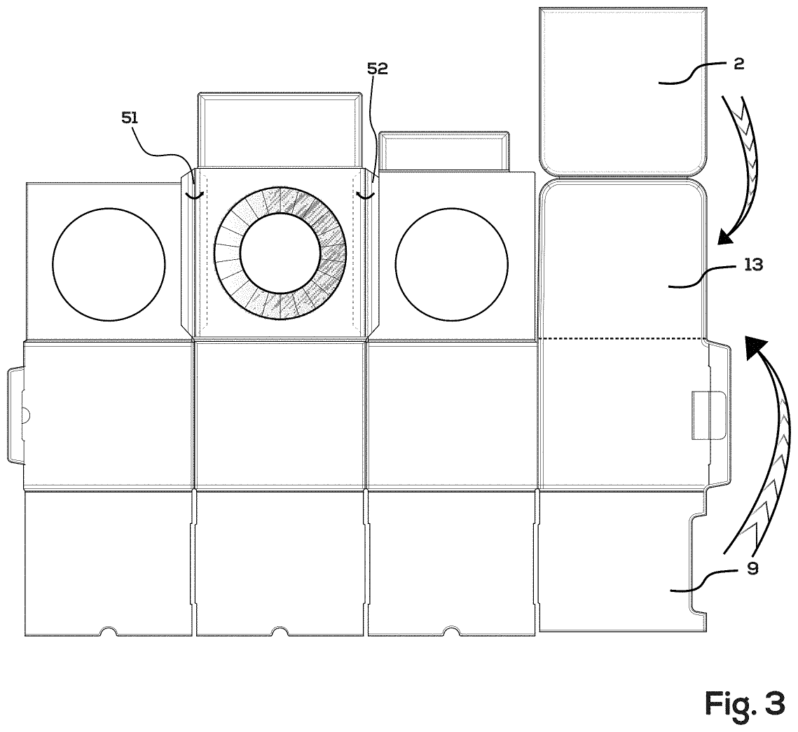

FIG. 3 The tall Marquee Support Panel/Back Panel 13 rises from the bottom of the product to the extended height of the Marquee Panel/Back-Board/Splash-Board/Billboard/Vertical Display Panel 2 to form the back of the invention. Besides continuing the graphic message from the front and side panels, its main function is to give additional support reinforcing the Marquee Panel/Vertical Display Panel 2. In the production process the Marquee Panel/Back-Board/Splash-Board/Billboard/Vertical Display Panel 2 is folded along the score line between Marquee Panel 2 and Marquee Support Panel/Back Panel 13. Glue is applied to permanently affix Marquee Panel 2 to Marquee Support Panel/Back Panel 13. This permanently adhered Marquee Panel/Back-Board/Splash-Board/Billboard/Vertical Display Panel now becomes 21. The double wall thickness of material adhered together adds rigidity and helps to keep the Marquee Panel/Vertical Display Panel 21 from bending.

It should be appreciated that the Marquee Panel/Back-Board/Splash-Board/Billboard/Vertical Display Panel 21 could take any shape within the confines of the ratio in the materials including but not limited to; rounded and angled corners, scalloped edges and cut-outs.

Additionally, to further strengthen the complete structure, Foundation Panel 9 is folded along the score line between Marquee Support Panel 13 and Foundation Panel 9. Glue is applied in the production process to permanently affix Foundation Panel 9 to Marquee Support Panel 13, this double-wall thickness permanently strengthens the complete product. By folding the Foundation Panel 9 along the score line between Marquee Support Panel 13 the Polypropylene coating on the continuous surface protects from moisture absorption at the base of the invention. Upon permanently adhering Foundation panel 9 to Marquee Support Panel 13 it will be numbered 91 hereafter.

The Polypropylene coated paper Feeding Deck Reinforcement flaps 51 and 52 are folded along the score lines and glued to the underside of the Feeding Deck 5 during the manufacturing process. This folded-over water resistant treated paper covers the open edge of the fluted corrugated paperboard substructure on the left and right side of the Feeding deck 5, to prevent water, splattered by the animals while drinking, from penetrating and absorbing into the otherwise open edges therefore weakening the fluted corrugated paperboard substrate.

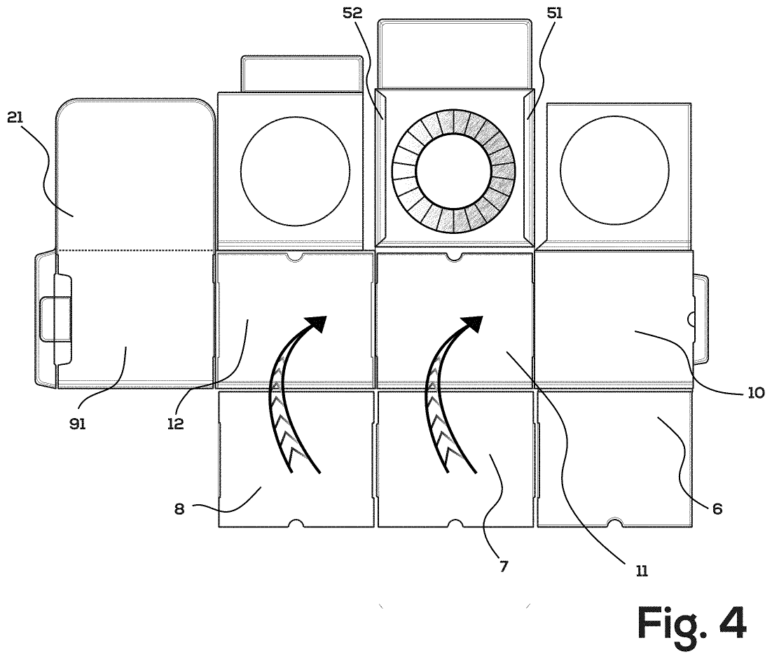

FIG. 4 The consumer begins the assembly process by folding the two Foundation Panels 7 and 8 along the score lines and laying them onto the Front Panel 11 and Right-Side Panel 12. Here as well the Polypropylene coating on the continuous surface protects from moisture absorption at the base of the invention.

The Feeding Deck Reinforcement Flaps 51 and 52 can be seen securely glued to the underside of Feeding Deck 5 protecting the otherwise open edge of the corrugated paperboard substrate on the left and right side of the Feeding Deck 5 from moisture absorption.

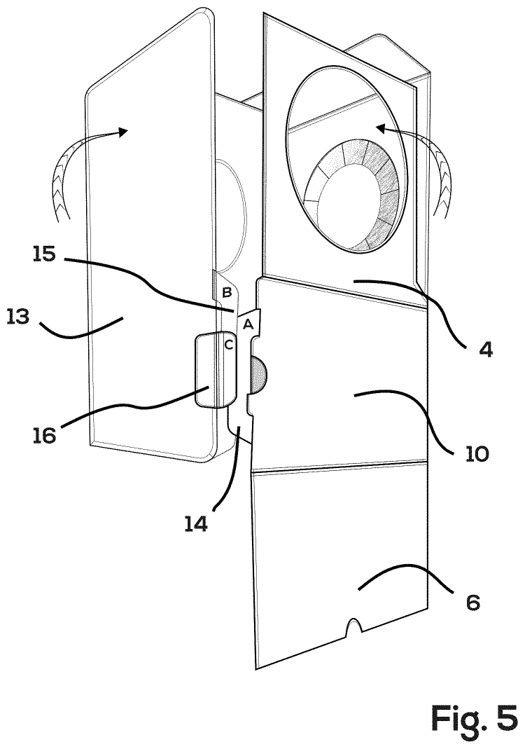

FIG. 5 The graphically enhanced Polypropylene coated fluted corrugated paper-board is folded along the score lines into a three-dimensional Feeder Stand Base by moving the Marquee Support Panel/Back Panel 13 toward Left Side Panel 10, thereby preparing for the interlocking of the three-dimensional Pet Feeder Stand Base.

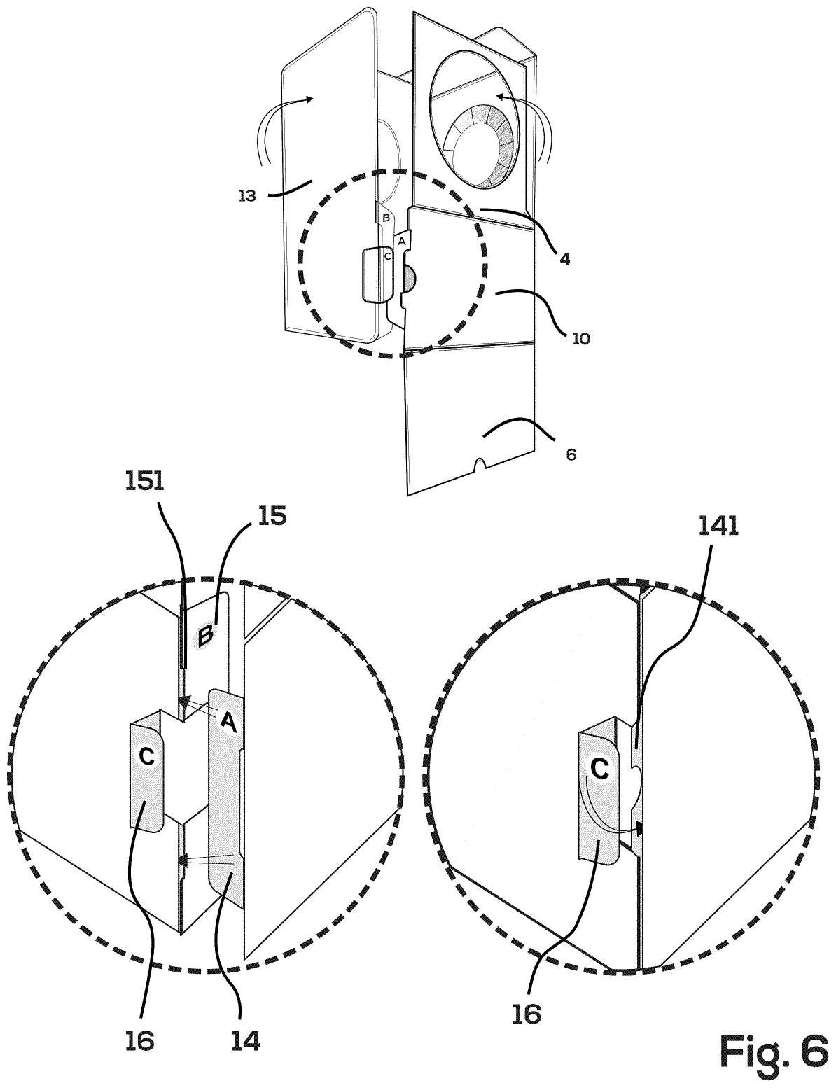

FIG. 6 Flap “A” 14 is inserted into the pre-cut Flap slot 151 in Flap “B” 15. By inserting “Flap C” 16 into the pre-cut Flap slot 141 of “Flap A” 14 the panels are securely interlocked, and a permanent three-dimensional Pet Feeder Stand Base has been assembled, allowing the 4-color process printing comprised of commercial advertisements, promotions, inspirational messages, and entertainment to be continuously shown throughout all visible panels of the invention.

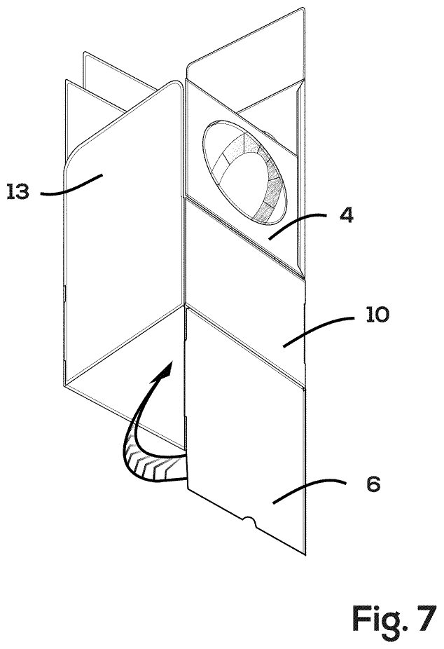

FIG. 7 Foundation Panel 6 is now folded across the fold line and folded up-and-inside the Pet Feeder Stand Base, thereby interlocking the Foundation Panels 6, 7, 8, and 9 with each other at the four inside corners of the Feeder Stand Base, giving additional strength and rigidity to the invention, while the Polypropylene coating on the continuous surface protects from moisture absorption at the base of the product. These interlocking Foundations Panels are integral in the vertical support of the Feeding Deck 5 and a key component making the invention a robust and stable Raised Pet Feeder Stand for domesticated animals of all sizes.

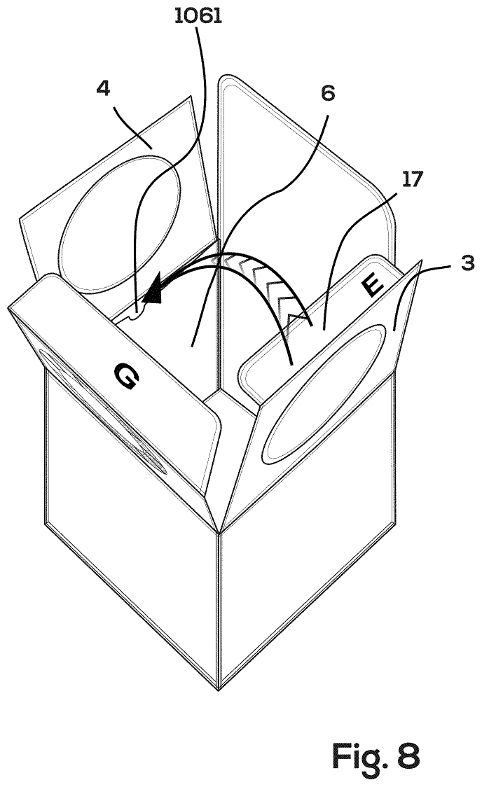

FIG. 8 The Feeding Deck Support Panel 3 is folded across the invention and Flap “E” 17 is inserted into slot 1061, created by the space between Left Side Panel 10 and Foundation Panel 6, a key component of the construction as it creates an integral reinforced support system for the Feeding Deck 5.

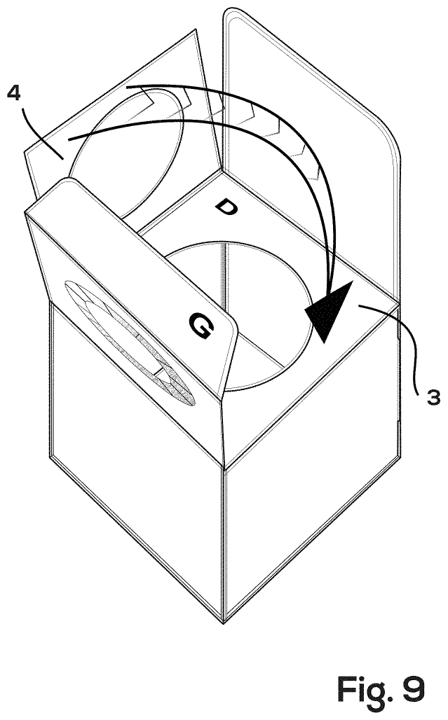

FIG. 9 The Center Support Panel 4 is folded along the score line across Feeding Deck Support Panel 3 thereby securing Feeding Deck Support Panel 3 in place while giving an additional layer of support for Feeding Deck 5. Folding Center Support Panel 4 from the opposite direction of Feeding Deck Support Panel 3 offers increased rigidity to the overall structure. By folding this layer the Polypropylene coating on the continuous surface protects from moisture absorption at the otherwise exposed corrugated edge. Feeding Deck Support Panel 3 and Center Support Panel 4 combined support Feeding Deck 5 so it can carry the weight of the food or water in the bowl as well as the weight and downward force from the pet consuming the food/water.

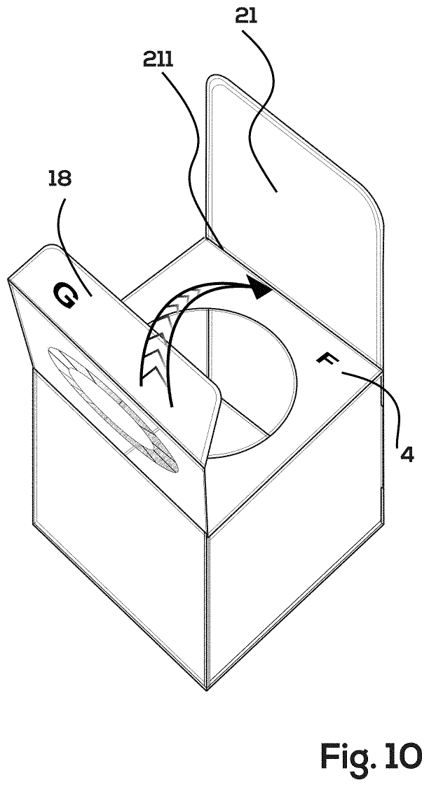

FIG. 10 Feeding Deck 5 is folded from front to back of the invention and Flap “G” 18 slides into slot 211, created by Marquee Panel/Back-Board/Splash-Board/Billboard/Vertical Display Panel 21, Feeding Deck Support Panel 3, and Center Support Panel 4, that holds it in place. With Feeding Deck 5 securely in place, the Feeder Cradle 19, an EVA foam ring with multiple triangular die cut “fingers” permanently adhered around the bowl cut-out of Feeding Deck 5 is revealed and ready to receive the Feeding Bowl 22. This completes the fold-for-use assembly of the invention.

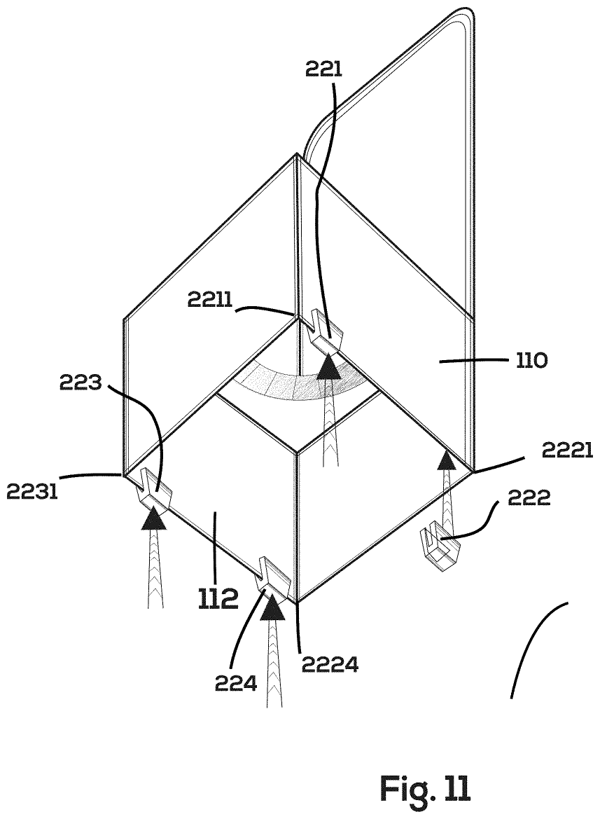

FIG. 11 is a bottom up view of the Raised Pet Feeder Stand showing how the four plastic risers/feet/cushions 221, 222, 223 and 224 are attached to the bottom edges of the folded Left and Right Base Panel 110 and 112. The plastic risers/feet/cushions raise the Pet Feeder Stand off the floor to protect the four fluted corrugated unprotected inside corners 2211; 2221, 2231 and 2241 from absorbing water spillage, that may be on the floor due to the splattering of an animal drinking water from the feeding bowl, as well as water used for cleaning tile or hardwood floors.

Additionally, the Polypropylene risers/feet/cushions 221-224 help prevent the feeder from moving or sliding along the floor while the pet eats or drinks from the bowl.

It should be appreciated that the risers/feet/cushions can take any shape within the confines of the usage and materials.

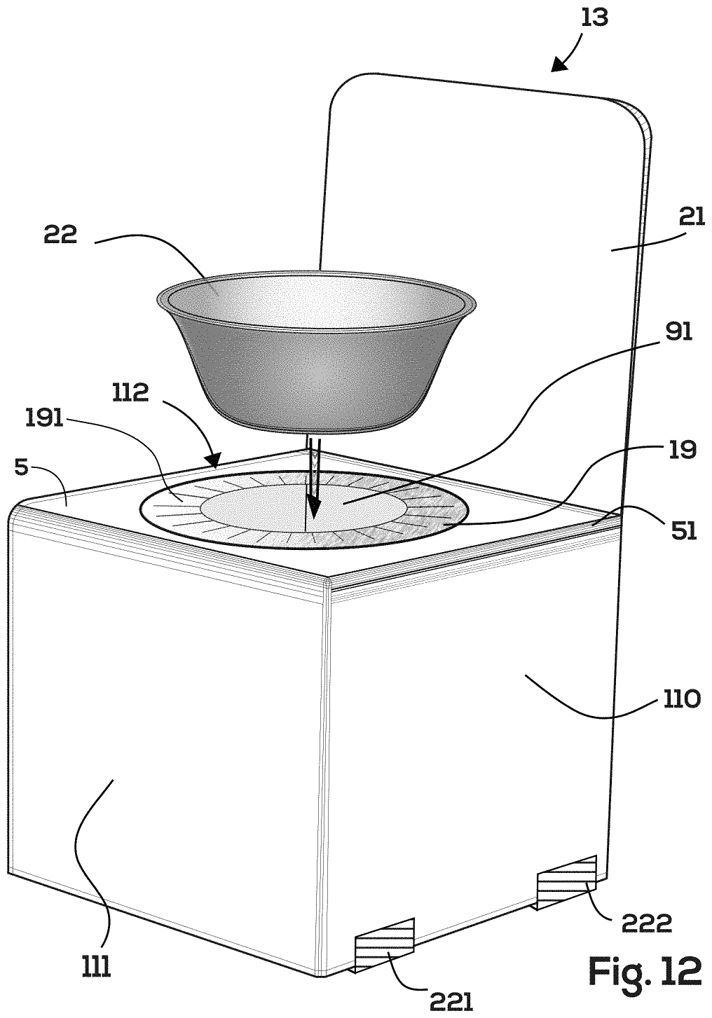

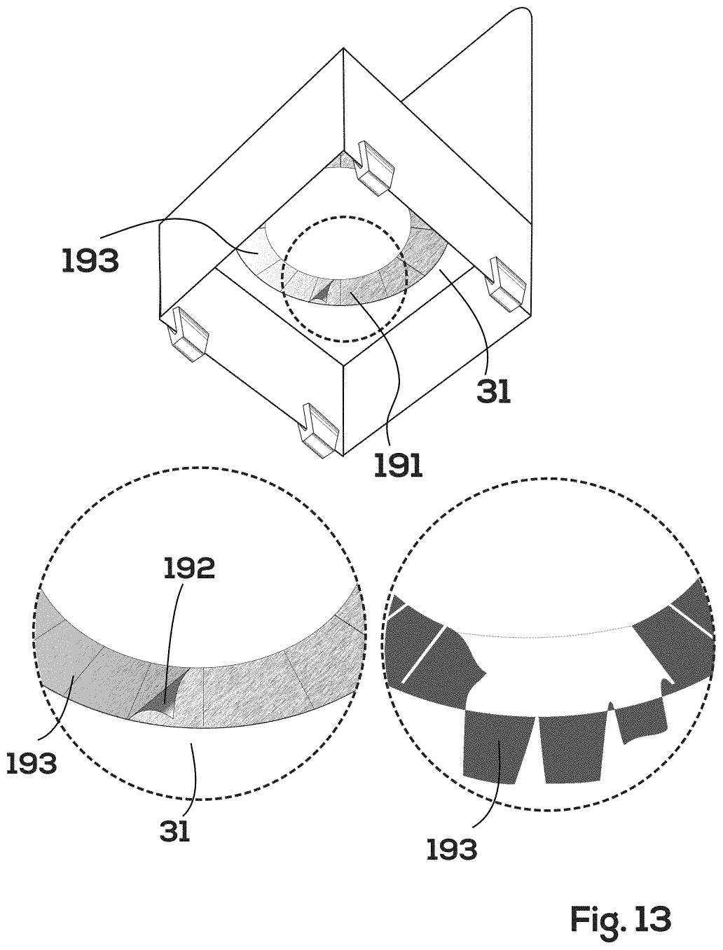

FIG. 12 The exposed Feeder Cradle EVA foam ring with multiple triangular die-cut “fingers” 19 adhered around the bowl cut-out of the Feeding Deck 5 has three functions shown in FIG. 12 and FIG. 13: Function #1, the Feeder Cradle EVA Foam Ring 19 acts as a gasket to prevent moisture from getting under the lip of the Feeding Bowl 22 once it is lowered into the hole of Feeding Deck 5. Function #2, as a second layer of protection, the triangular shaped EVA foam die-cut “fingers” 191 prevent moisture from being absorbed into the open corrugated fluting around the bowl cut-out of the Feeding Deck 5, Center Support Panel 4, and Feeding Deck Support Panel 3 once the Feeding Bowl 22 is lowered into position.

It should be appreciated that Pet Bowls can be developed that can hold both food and water in a partitioned dish.

FIG. 13: Function #3 is an optional step for the consumer to take. Removing the protective cover 192 from the underside of the EVA foam die-cut “fingers” 191 exposes the adhesive surface, then folding the “fingers” inward and upward adhering the three Deck Panel layers (Feeding Deck 5, Center Support Panel 4, and Feeding Deck Support Panel 3) firmly together solidifying the feeding deck construction adding tensile strength to the Feeding Deck Assembly. This step is optional, if the intended use of the invention is for seasonal decor or travel, as it makes it more difficult to unfold.

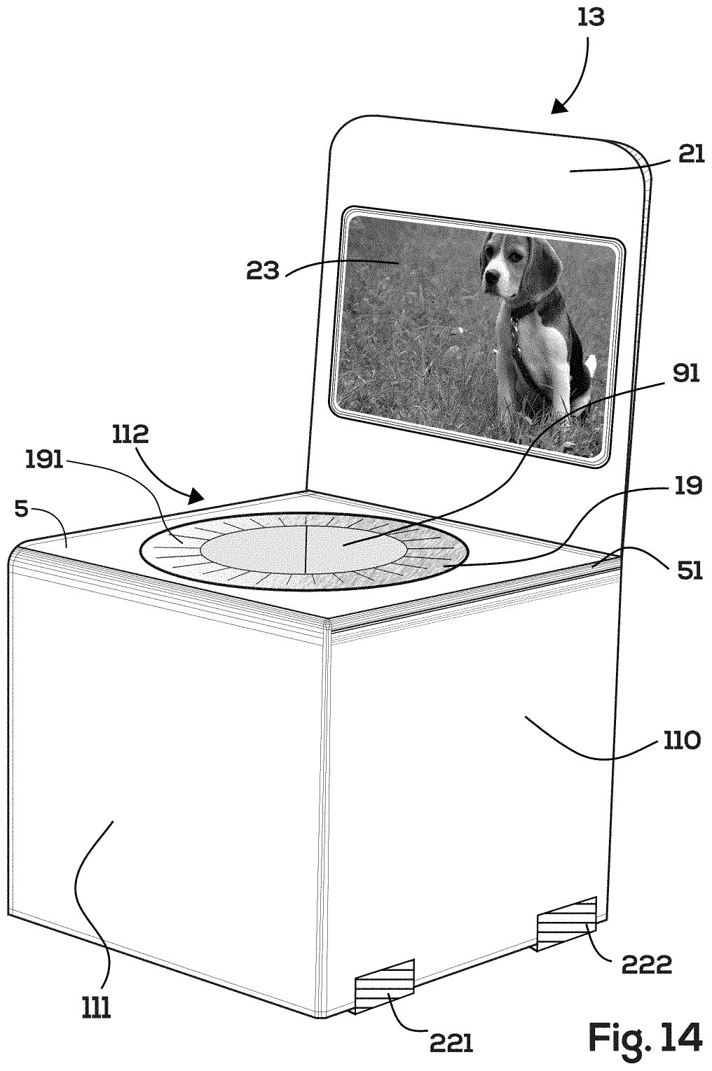

FIG. 14 In embodiment #2 the same principles and materials will be used as in Embodiment 1, but the Marquee Panel/Back-Board/Splash-Board/Billboard/Vertical Display Panel 21 will feature a photo cut-out as shown in FIG. 14. The photo cut-out is die-cut into the Marquee Panel 2 prior to adhesion to the Marquee Support Panel 13. A photo support frame assembly is adhered between Marquee Panel 2 and Marquee Support Panel 13 to hold the photo in the desired position. A Layer of clear acetate is adhered to the photo support frame assembly on backside of Marquee Panel 2. Once Marquee Panel 2 and Marquee Support Panel 13 are permanently adhered together, incorporating the photo support frame assembly and clear acetate, creating a Media Display Area 23 with acetate cover. The consumer can slide photos into the Media Display Area 23 behind the protected clear acetate cover displaying the photo in the front of the Marquee Panel 21.

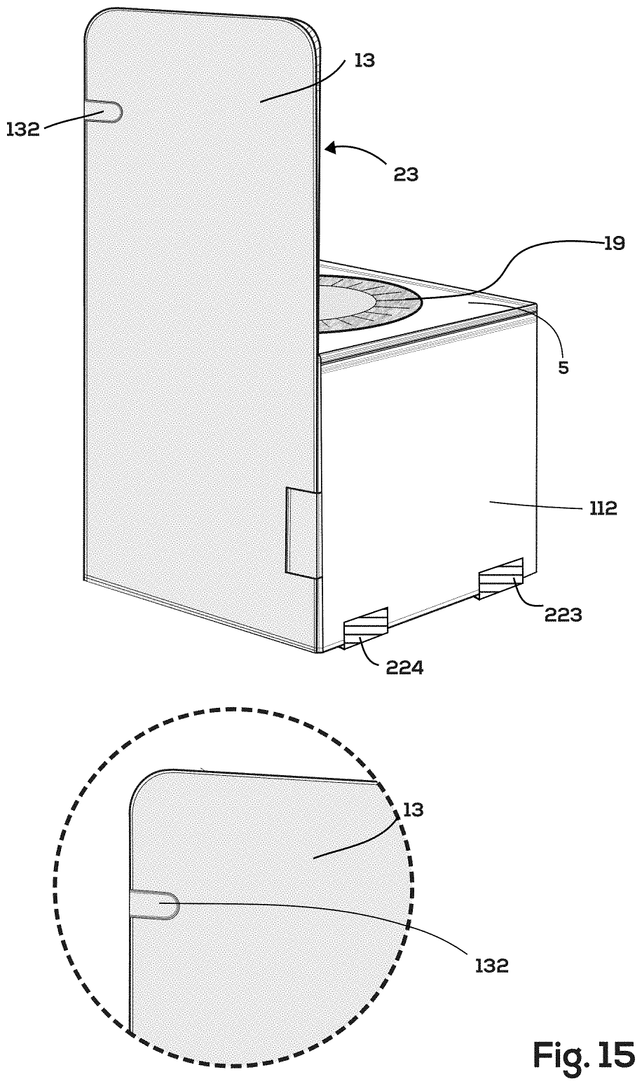

FIG. 15 A finger cut-out 132 is added to the Marquee Support Panel 13 allowing the consumer to slide the photo far enough into the Media Display Area with protective acetate cover 23 to be visible and centered in the front of Marquee Panel 21.

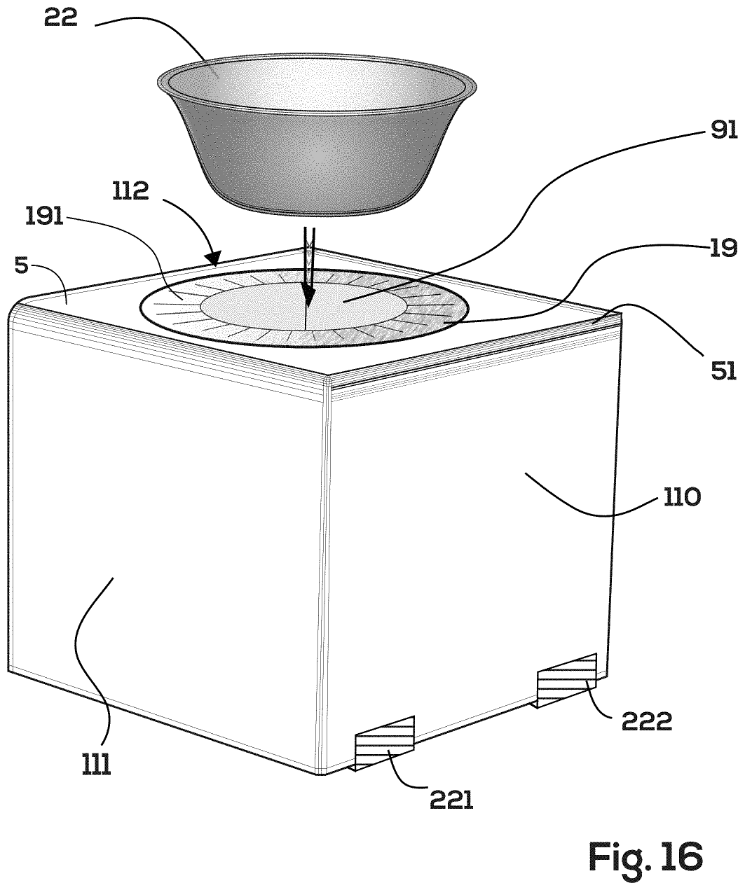

FIG. 16 In embodiment #3 the same principles and materials are used, but the Marquee Panel/Back-Board/Splash-Board/Billboard/Vertical Display Panel 21 will be removed, creating a Raised Pet Feeder Table.

With respect to the current invention, dimensions should be understood as follows: height refers to the vertical elevation of a structural element; length refers to the horizontal span of a structural element; and width refers to the depth of a structural element.

In an example embodiment, the dimensions of the assembled Raised Pet Feeder Stand are approximately 8.75 inches long; 8.75 inches deep and 15.25 inches tall (to the top of Marquee Support Panel 13) with a feeding height of 7.5 inches (Feeding deck 5) and weighs approximately 15 ounces (without feeding bowl).

In another example embodiment, the dimensions of the assembled Raised Pet Feeder Stand are approximately 11.5 inches long; 11.5 inches deep and 19.25 inches tall (to the top of Marquee Support Panel 13) with a feeding height of 10 inches (Feeding deck 5) and weighs approximately 28 ounces (without feeding bowl).

In another example embodiment the dimensions of the assembled Raised Pet Feeder Stand are approximately 7 inches long; 7 inches deep and 10.25 inches tall (to the top of Marquee Support Panel 13) with a feeding height of 4.25 inches (Feeding deck 5) and weighs approximately 8 ounces (without feeding bowl).

The dimensions discussed above are merely illustrative and are not intended to limit the scope of the invention. Additionally, the ratios of the dimensions discussed above are not intended to limit the scope of the invention. Various dimensions and ratios, as well as the quantity of feeding bowls accommodated are contemplated.

In the example embodiment, the Raised Pet Feeder Stand is made from Polypropylene coated 4-color process printed paper permanently adhered to fluted corrugated paper board. It could also be made from corrugated plastic sheeting with printed plastic foil adhered to it or any other suitable alternative material.

In another embodiment the same principals and materials will be used to produce raised decorative party tray holders. The raised corrugated paper tray holder will hold either stainless steel servings trays, tin foil trays, paper plates, etc. while delivering any kind of commercial advertisement, promotion, inspirational message, or simply entertainment through the Marquee Panel/Billboard Panel. The item would hold stainless steel serving food trays.

In another embodiment the same principal and materials will be used to produce raised decorative plant stands. The pet bowl will be replaced by a plastic rimmed planter. The Marquee Panel/Billboard will deliver any kind of commercial advertisement, promotion, inspirational message, or simply entertainment behind trailing vines from the planter in front.

Thus, it is seen that the objects of the present invention are efficiently obtained, although modifications and changes to the invention should be readily apparent to those having ordinary skills in the art, which modifications are intended to be within the spirit and the scope of the invention as claimed. It is also understood that the foregoing description is illustrative of the present invention and should not be considered as limiting. Therefore, other embodiments of the present invention are possible without departing from the spirit and scope of the present invention.

Companies, advertisers or organizations who want to send a promotional or inspirational message, would develop graphic artwork emphasizing their message. This graphic artwork would then be printed onto the raised stand and the Marquee Panel/Billboard transforming the Raised Stand into an efficient message-board that can be used to deliver any kind of advertisement, promotion, inspirational message, or simply entertainment.

The Marquee Panel/Billboard doubles as an extended back-splash panel to prevent food or liquids from splashing and staining/damaging the surface behind the feeder. When drinking from bowls or eating canned pet food, domesticated animals often splatter on surfaces behind the feeder.

Due to the materials used to make conventional raised pet feeders they cannot be easily used as a seasonal decoration or travel accessory as they do not fold for easy storage. Materials used for most conventional raised pet feeders include wood, metal, and molded plastics. If they can be dismantled for seasonal storage or travel at all, multiple parts and hardware would be required and could easily be lost or misplaced leaving the product unusable in the future.

Furthermore, the bulky nature or heavier weight of most raised pet feeders result in higher transportation cost for the retailer which translates to a higher cost to the consumer than the collapsible lightweight invention.

None of the raised pet feeders on the market today address the five key issues in a combined approach: #1—Efficiency in assembly and disassembly; #2—efficiency in transportation; #3—transformation of a pet feeder into a message board/billboard capable of delivering advertising and promotional content, inspirational messages, or graphic entertainment; #4—an enlarged back-splash to prevent spillage that doubles as a Marquee/Billboard, #5—a substrate using polypropylene coated corrugated paper with vibrant printed graphics.

### REFERENCE NUMERALS

2 Marquee Panel/Back-Board/Splash-Board/Billboard/Vertical Display Panel
3 Feeding Deck Support Panel
4 Center Support Panel
5 Feeding Deck
6 Left Foundations Panel
7 Front Foundation Panel
8 Right Foundation Panel
9 Back Foundation Panel
10 Left Side Panel
11 Front Panel
12 Right Side Panel
13 Marquee Support Panel/Back panel
14 Flap “A”
15 Flap “B”
16 Flap “C”
17 Flap “E”
18 Flap “G”
19 Feeder Cradle—EVA Foam Ring with adhesive backing
21 Marquee Panel/Back-Board/Splash-Board/Billboard/Vertical Display Panel 2 permanently adhered to Marquee Support Panel/Back panel 13
22 Feeding Bowl
23 Media Display Area with protective acetate cover
51 Left Feeding Deck Reinforcement Flaps
52 Right Feeding Deck Reinforcement Flaps
91 Back Foundation Panel 9 folded and permanently adhered to backside of 13 Marquee Support Panel/Back Panel
110 Left Base Panel (Folded up)
111 Front Base Panel (folded up)
112 Right Base Panel (folded up)
131 Fluted corrugated paperboard substrate
132 Finger cut-out on back of Media Display Area
141 Pre-cut Flap slot if Flap “A”
151 Pre-cut Flap slot in Flap “B”
191 Triangular shaped EVA foam die-cut “fingers”
192 Protective cover over adhesive backing on Triangular shaped EVA foam die-cut “fingers”
211 Slot between Marquee Panel/Back-Board/Splash-Board/Billboard/Vertical Display Panel 21 and Feeding Deck Support Panel 4 which receives Flap “G” 18
221-224 Polypropylene Riser/“Foot”/Cushion
1061 Slot created by folding Left Side Panel 10 and the Foundation Panel 6 onto each other
2211-2241 Unprotected inside corner after completed assembly in fluted corrugated Substrate

What is claimed is:

1. An apparatus comprising:
a plurality of double sided Polypropylene coated fluted corrugated cardboard panels vibrantly printed on one side, strategically fixedly joined together from a single piece of material and hingedly connected by at least one of their edges, each panel being scored along at least one edge permitting folding
a substantially, collapse resistant and water resistant cube-shaped structure comprising a top side panel, front side panel, left side panel, right side panel, and a rear side panel whereas the elevation of the rear side panel is extended beyond the elevation of the top side of the cube-shaped structure at a height approximately the same measure as the height of the cube-shaped structure
an extension of said extended rear side panel is scored along the hinge line at the top of the extended rear side panel and hingedly connected by its edges, folded over and permanently adhered to the inside of the extended rear side panel, thereby creating a double wall thick extended elevated rear panel with a vibrantly printed Polypropylene coated front and back side
the left side, front side, and right side are fixedly joined together being scored along lines permitting folding thereby hingedly connecting said panels by their edges the right side and rear side are fixedly joined together being scored along a line permitting folding thereby hingedly connecting said panels by their edges whereas the left side and the rear side inter-engage and are latched together with an integrated interlocking mechanism when folded to form the cube-shape structure
three panels fixedly joined at the top of the left side panel, right side panel and front side panel each hingedly connected to one of said panels being scored along the hinge line and folded from left to right across the open cube-shaped structure, followed by right to left across the cube-shaped structure, being secured by top side panel fixedly joined and hingedly connected to front side, folded across the cube-shaped structure from front to back whereby an extension of said top side panel is pressure-fit into a pocket formed by the interaction of said panels and the rear side panel thereby creating the top side of the cube-shaped structure
said three panels of the top side of the cube-structure are having corresponding center die-cut holes
extended flaps on the left side and right side of the top side panel of the cube-shaped structure are fixedly joined to top panel scored along the hinge line and hingedly connected by their edges and are folded completely under the top panel and permanently adhered to the underside of the top panel, thereby extending the Polypropylene coating over the edge of the left side and right side of the top side panel making the edge resistant to moisture absorption
four foundation panels fixedly joined together being scored along lines permitting folding thereby hingedly connecting said panels by their edges to the bottom side of the left side panel, the bottom side of the right side panel, the bottom side of the front side panel and the bottom side of the rear side panel and are folded upward into the cube structure creating a collapse-resistant base with a Polypropylene coated surface on the bottom edge of cube-shaped structure
an adhesive backed die-cut EVA foam ring with partially cut triangular shaped extensions is permanently adhered to the top side panel of the cube-shaped structure around the center die-cut hole, whereby the adhesive backed triangular extensions expand freely into the die-cut hole on the top side panel of the cube-shaped structure four molded plastic injected Risers slide onto the Polypropylene coated surface on the bottom edge of the left side panel, and the right side panel of the cube-shaped structure near its four corners

2. The apparatus of claim 1, wherein the complete paper substrate of the plurality of panels is graphically enhanced on one side or two sides with commercial advertisement, promotions, and/or entertainment

3. The apparatus of claim 1, wherein only the paper substrate of the extended elevation of the rear panel is vibrantly printed and graphically enhanced with commercial advertisement, promotions, and/or entertainment

4. The apparatus of claim 1 wherein only the graphically enhanced side of the plurality of paper panels is made water resistant by Polypropylene coating; the backside of the fluted corrugated paperboard structure would remain uncoated

5. The apparatus of claim 1 wherein the water-resistant coating is achieved by other plastic based material coatings

6. The apparatus of claim 1 wherein different materials for the substructure are used, especially corrugated sheet plastic

7. The apparatus of claim 1 wherein sound is added either by motion activation or other initiation

8. The apparatus of claim 1 wherein light is added either by motion activation or other initiation

9. The apparatus of claim 1 wherein video recording and/or playback is added either by motion activation or other initiation

10. The apparatus of claim 1, wherein the three panels of the top side of the cube-shaped structure currently with one corresponding center die-cut hole will be given additional side by side die-cut holes

11. The apparatus of claim 1, wherein the vibrantly printed Polypropylene coated front side of the extended rear side panel is cut out to accommodate media in the form of photos or other media

12. The apparatus of claim 11, whereby a clear acetate shielded photo/media support frame is constructed between the double wall thick front and rear panels of the extended rear panel

13. The apparatus of claim 1 wherein there is no elevation of the rear side panel extending beyond the elevation of the top side of the cube-shaped structure

14. The apparatus of claim 1 wherein the elevation of the rear side panel is extended beyond the elevation of the top side of the cube-shaped structure at any height beyond the height of the cube-shaped structure

15. The apparatus of claim 1 wherein the four foundation panels are excluded from the structure thus the bottom of the cube-shaped structure is comprised of left side panel, right side panel, front side panel and rear side panel only

16. The apparatus of claim 1 wherein the adhesive backed die-cut EVA foam ring with partially cut triangular shaped extensions is excluded

17. The apparatus of claim 1 wherein the four molded plastic injected Risers are excluded
